(19) United States
(12) Patent Application Publication
(10) Pub. No.: US 2025/0346012 A1
(43) Pub. Date: Nov. 13, 2025

(54) PRESS SYSTEM AND CONTROL METHOD OF PRESS SYSTEM

(71) Applicants: AMADA CO., LTD., Kanagawa (JP); AMADA PRESS SYSTEM CO., LTD., Kanagawa (JP)

(72) Inventor: Kouichi GOTO, Kanagawa (JP)

(73) Assignees: AMADA CO., LTD., Kanagawa (JP); AMADA PRESS SYSTEM CO., LTD., Kanagawa (JP)

(21) Appl. No.: 18/868,750

(22) PCT Filed: Jun. 6, 2023
(86) PCT No.: PCT/JP2023/021001

§ 371 Date: Nov. 24, 2024

(30) Foreign Application Priority Data
Jun. 10, 2022 (JP) 2022-094487

(51) Int. Cl. B30B 15/14; B30B 15/26; B30B 15/30

(52) U.S. Cl. CPC B30B 15/148; B30B 15/146; B30B 15/30; B30B 15/26

(57) ABSTRACT

A press system and method that can easily avoid collisions and improve productivity regardless of a workpiece conveyance pattern by a workpiece conveyance device. Press devices Pn and Pn+1 each send signals corresponding to an angle of a crankshaft to a line controller, and robots Rm, Rm−1, and Rm+1 each send signals corresponding to a state of conveyance of a workpiece to the line controller. The line controller, based on the signals, determines whether to permit entry to each of the multiple regions C1 to C10. It then sends an entry permission signal for each of the multiple regions C1 to C10 to the robot Rm based on determined results, and the robot Rm performs loading or unloading based on the entry permission signal.

### TECHNICAL FIELD

The present invention relates to a press system and a control method of the press system.

### BACKGROUND ART

Conventionally, there is a tandem press system equipped with multiple press devices and multiple robots, where a robot that conveys workpieces is placed between the press devices (see, for example, Patent Literature 1). In such a press system, in order to avoid collisions between a press device and a robot, or between robots themselves, the conveyance of workpieces by robots and the processing of the workpieces by the press devices are alternately performed (hereinafter referred to as an “alternate operation”). In the alternate operation, the loading and unloading of workpieces by the robots is carried out simultaneously, and after the robots return to their designated positions, processing by the press devices is carried out simultaneously. Then, after the processing by the press devices is completed, the loading and unloading of the workpieces by the robots is carried out simultaneously, and after the robots return to their designated positions, the processing by the press devices is carried out simultaneously, . . . , and this series of operations is repeated. In other words, the press devices cannot process until the robots return to their designated positions, and the robots cannot load or unload the workpieces until the processing by the press devices is completed. In the alternate operation, collisions between devices can be avoided, but productivity decreases. As a method to avoid collisions while increasing productivity, for example, there is a method of conducting a simulation of conveyance of workpieces before operating a press system and determining a timing for starting each robot (hereinafter referred to as a “start timing”). Additionally, there is a method of actually operating a press system and repeating trials to set the start timing of robots.

### CITATION LIST

### Patent Literature

Patent Literature 1: Japanese Patent No. 4514733

### SUMMARY OF INVENTION

### Technical Problem

However, in the method of performing a simulation before operating the press system, it is necessary to perform the simulation for each conveyance pattern by a robot. Additionally, a dedicated application is required to perform the simulation. In addition, in the method of actually operating the press system and repeating trials, repeating the trials itself requires time. Therefore, it is required to achieve both collision avoidance and productivity improvement without the need for pre-operation simulation of the press system and without the need for actually repeating the trials. In other words, regardless of the workpiece conveyance pattern by a robot, it is required to easily avoid collisions and improve productivity.

The present invention has been made in view of the above circumstances, and an exemplary object is to provide a press system and a control method for the press system that can easily avoid collisions and improve productivity regardless of a workpiece conveyance pattern by a workpiece conveyance device.

### Solution to Problem

To solve the problem, the present invention comprises the following configuration.
(1) A press system including: a press device including a crankshaft and a slide configured to move up and down according to rotation of the crankshaft, the press device being configured to process a workpiece with dies mounted on the slide; a conveyance device configured to perform loading of the workpiece into the press device or unloading of the workpiece from the press device, and convey the workpiece; and control means configured to control the press device and the conveyance device, in which the press system further includes: a predetermined conveyance device; a front press device disposed on an upstream side in a conveyance direction of the workpiece with respect to the predetermined conveyance device; a rear press device disposed on a downstream side in the conveyance direction with respect to the predetermined conveyance device; a front conveyance device disposed on the upstream side in the conveyance direction with respect to the predetermined conveyance device; a rear conveyance device disposed on the downstream side in the conveyance direction with respect to the predetermined conveyance device; and a storage unit configured to store information on multiple regions set to avoid interference between the predetermined conveyance device and the front press device, interference between the predetermined conveyance device and the rear press device, interference between the predetermined conveyance device and the front conveyance device, and interference between the predetermined conveyance device and the rear conveyance device, the front press device and the rear press device each send a signal corresponding to an angle of the crankshaft to the control means, the predetermined conveyance device, the front conveyance device, and the rear conveyance device each send a signal corresponding to a state of conveyance of the workpiece to the control means, the control means determines whether to permit entry to each of the multiple regions for each of the multiple regions based on signals corresponding to the angle of the crankshaft sent from the front press device and the rear press device, as well as signals corresponding to the state of conveyance of the workpiece sent from the predetermined conveyance device, the front conveyance device, and the rear conveyance device, and sends an entry permission signal for each of the multiple regions to the predetermined conveyance device based on determined results, and the predetermined conveyance device performs the loading or the unloading based on the entry permission signal.

Further objects or other features of the present invention will be made clear by a preferred embodiment described below with reference to the accompanying drawings.

### Advantageous Effects of Invention

According to an aspect of the present invention, it is possible to provide a press system and a method for controlling the press system that can easily avoid collisions and improve productivity regardless of a workpiece conveyance pattern by a workpiece conveyance device.

### BRIEF DESCRIPTION OF DRAWINGS

FIG. 1 is a schematic perspective view showing a configuration of a press system of an embodiment.

FIG. 2 is a schematic perspective view showing a configuration of a press device of the embodiment.

FIG. 3 is a schematic perspective view showing a configuration of a robot according to the embodiment.

FIG. 4 is a block diagram of the press system according to the embodiment.

FIG. 5 is a diagram explaining signals sent and received between each device in the embodiment.

FIG. 6 is a diagram showing relationship between an angle of the crankshaft in the embodiment and a predetermined timing in each region and processing.

FIG. 7 is a diagram explaining a region of the embodiment.

FIG. 8 is a flowchart explaining an operation of the robot in the embodiment.

### DESCRIPTION OF EMBODIMENT

In the following description, a direction in which a workpiece is conveyed is referred to as a “conveyance direction” or a “left-right direction”. Here, an upstream side in the conveyance direction is defined as left, and a downstream side in the conveyance direction is defined as right. Also, a direction perpendicular to the conveyance direction (left-right direction) in a horizontal plane is defined as a front-rear direction, with a front side in the front-rear direction being a front of a press system, and a rear side in the front-rear direction being a back of the press system. Furthermore, a direction perpendicular to the horizontal plane, that is, a direction perpendicular to the conveyance direction (left-right direction) and the front-back direction, is defined as a vertical direction. In a press device of the press system, a height of the workpiece being conveyed while processing is being performed (for example, the height based on the floor where the press system is installed) is referred to as a “processing height”.

### EMBODIMENT

### <Press System>

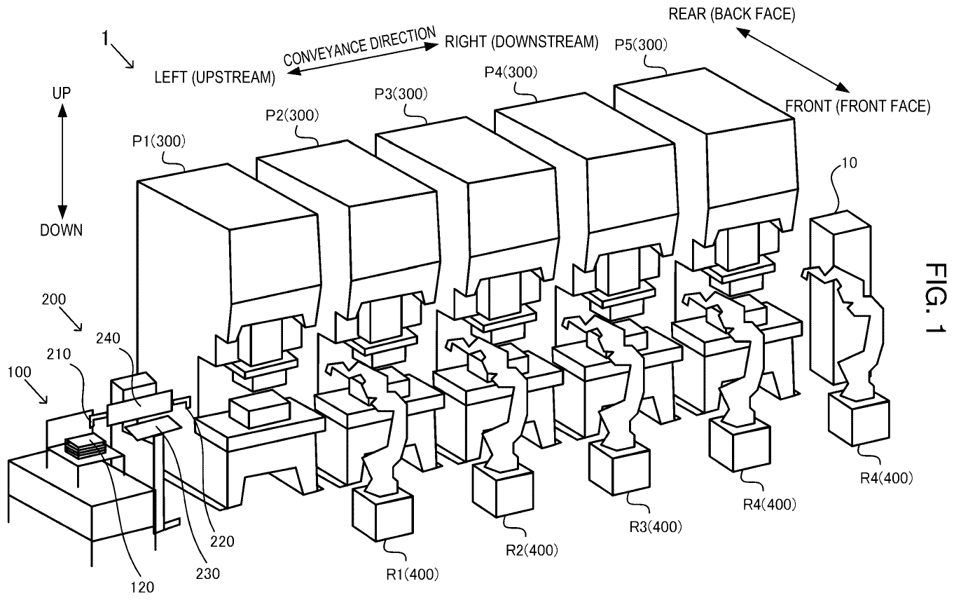

FIG. 1 is a schematic perspective view showing a configuration of a press system 1 of a present embodiment. FIG. 1 also shows a workpiece conveyance direction, as well as an upstream, a downstream, a front-rear direction, and a vertical direction. The press system 1 of the present embodiment includes a line controller 10, a lifter 100, a horizontal feeder 200, a die press device (hereinafter referred to as a “press device”) 300, and a robot 400 which is a workpiece conveyance device. The lifter 100, the horizontal feeder 200, the press device 300, and the robot 400 operate in conjunction with a processing operation of the press device 300.

The line controller 10 controls the entire press system 1. Details will be described later. A plurality of press devices 300 are provided from upstream to downstream in the workpiece conveyance direction. The press devices 300 are denoted as a press device P1, a press device P2, . . . , a press device Pn, . . . from upstream to downstream in the conveyance direction. Here, n is an integer greater than or equal to 1 (n≥1).

A plurality of robots 400 are installed from upstream to downstream in the workpiece conveyance direction. The robots 400 are denoted as a robot R1, a robot R2, . . . , a robot Rm, . . . from upstream to downstream in the conveyance direction. Here, m is an integer greater than or equal to 1 (m≥1). In FIG. 1, the press devices P1 to P5 and the robots R1 to R5 are shown. A robot 400 is positioned between the press devices 300 when the press system 1 is viewed from the front. The robot 400 does not necessarily have to be positioned between the press devices 300 when viewed from above the press system 1. For example, as shown in FIG. 1, the robot may be located between the press devices 300 in the conveyance direction (left-right direction) and may be positioned in front of a press device 300 when viewed from above. In the following description, when it is stated that the robot 400 is positioned between the press devices 300, it refers to an arrangement as shown in FIG. 1.

Here, when the robot 400 is placed between the press devices 300, the arrangement is as follows in detail. The robot R1 is placed between the press device P1 and the press device P2. At this time, from the perspective of the robot R1, the press device P1 is the press device on the upstream side in the conveyance direction, and the press device P2 is the press device on the downstream side. In addition, from the perspective of the press device P1, the robot R1 is positioned on the downstream side in the conveyance direction, and from the perspective of the press device P2, the robot R1 is positioned on the upstream side. Similarly, the robot R2 is positioned between the press device P2 and the press device P3. At this time, from the perspective of the robot R2, the press device P2 is the press device on the upstream side in the conveyance direction, and the press device P3 is the press device on the downstream side. In addition, from the perspective of the press device P2, the robot R2 is positioned on the downstream side in the conveyance direction, and from the perspective of the press device P3, the robot R2 is positioned on the upstream side.

Similarly, the robot Rm, which is a predetermined conveyance device, is disposed between the press device Pn, which is a front press device, and the press device Pn+1, which is a rear press device. At this time, from the perspective of the robot Rm, the press device Pn is the upstream press device in the conveyance direction, and the press device Pn+1 is the downstream press device. In addition, from the perspective of the press device Pn, the robot Rm is positioned on the downstream side in the conveyance direction, and from the perspective of the press device Pn+1, the robot Rm is positioned on the upstream side. Also, the robot Rm−1, which is a front conveyance device, is the robot on the upstream side of the robot Rm, and the robot Rm+1, which is a rear conveyance device, is the robot on the downstream side of the robot Rm.

### <Lifter and Horizontal Feeder>

The lifter 100 holds a workpiece 120, raises the held workpiece 120 to the processing height, and waits for the workpiece 120 to be gripped by the horizontal feeder 200. The horizontal feeder 200 includes an arm 240, a hand 210 provided on the upstream side in the conveyance direction of the arm 240, a hand 220 provided on the downstream side of the arm, and a table 230. The arm 240 can move in the conveyance direction and the vertical direction. The hands 210, 220 can, for example, suction and grip the workpiece 120 with air, and can release the suction to release the workpiece 120. Table 230 is a temporary placement location of the workpiece 120 for transferring the workpiece 120 from the hand 210 to the hand 220.

The horizontal feeder 200 grips the workpiece 120, which is on standby at the processing height in the lifter 100, by suction, moves the hand 210 horizontally, releases the suction, and places the workpiece 120 on the table 230. The hand 220 grips the workpiece 120 placed on the table 230 by suction, conveys (moves) the workpiece 120 to the press device 300, specifically to the press device P1, releases the suction, and places the workpiece 120 at a processing position of the press device P1 (a predetermined position of a lower die, which will be described later). In the press system 1 of FIG. 1, the horizontal feeder 200 is disposed between the lifter 100 and the press device P1, but the present invention is not limited thereto. For example, the robot 400 may be placed between the lifter 100 and the press device P1, and the workpiece 120 may be conveyed between the lifter 100 and the press device P1 by the robot 400.

### <Press Device>

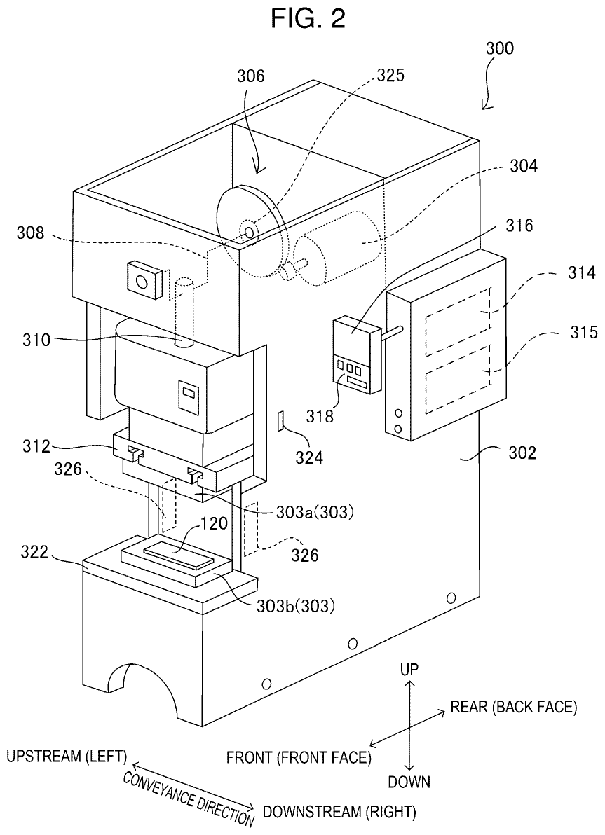

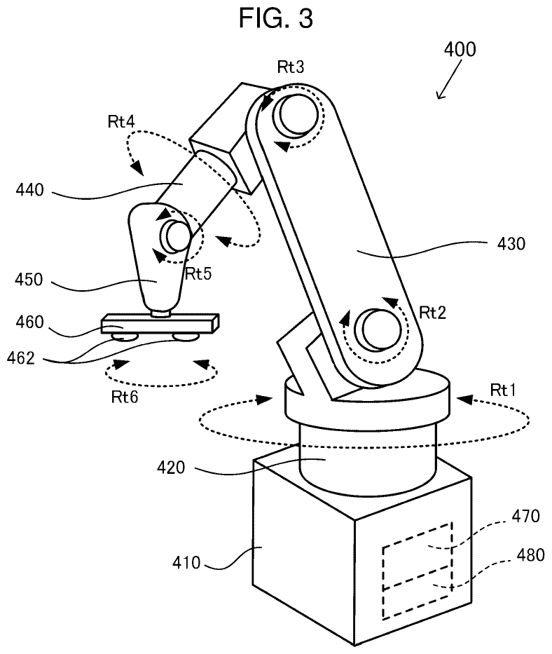

A press device 300 in FIG. 1 will be described by use of FIG. 2. FIG. 2 is a schematic perspective view showing a configuration of the press device 300 of the present embodiment, for example, the schematic view of the press device 300 of a straight-side one-piece frame type or of a C-frame type. FIG. 3 shows the conveyance direction of the workpiece 120, the upstream (left), the downstream (right), the vertical direction, and the front-rear direction (a front side and a back side) in the conveyance direction. The press device 300 is configured with a drive motor 304 (driving means), a transmission mechanism 306, a crankshaft 308, a connecting rod 310, a slide 312, and a bolster 322 inside and outside of a housing 302. Further, the press device 300 includes a controller 314, a storage unit 315, a display unit 316, and an input unit 318. Furthermore, the press device 300 includes a sensor 324, a rotary encoder 325, and guide gibs 326.

The drive motor 304 is, for example, a servo-controlled servomotor that vertically moves dies 303, which will be described later, via the transmission mechanism 306, the crankshaft 308, and the connecting rod 310 while controlling a rotational amount and a rotational direction. The transmission mechanism 306 is configured with transmission members such as a gear and a belt, for example, and transmits a rotation of a motor shaft of the drive motor 304 to the crankshaft 308. A control signal to the drive motor 304 is sent from the controller 314.

The crankshaft 308 and the connecting rod 310 are for converting a rotational movement of the motor shaft, which is transmitted by the transmission mechanism 306, into a reciprocating movement (a vertical movement in the present embodiment). The rotation of the motor shaft sets the crankshaft 308 to rotate, and the rotation is transmitted to the connecting rod 310 having a vicinity of one end connected to the crankshaft 308 so as to vertically move (to move in an ascending and descending manner) the connecting rod 310.

Further, the crankshaft 308 is provided with a rotary cam switch (not shown) that outputs an ON signal or an OFF signal in coordination with the rotation of the crankshaft 308. The rotary cam switch outputs the ON signal or the OFF signal when, for example, the rotation of the crankshaft 308 reaches a predetermined angle, in other words, reaches a predetermined timing during the processing operation. A timing at which the rotary cam switch outputs the ON signal (or the OFF signal) is hereinafter referred to as an “output timing.” The controller 314 operates in conjunction with other devices of the press system 1 based on the signal output from the rotary cam switch, performing the processing operation.

The slide 312 is connected to a vicinity of the other end of the connecting rod 310. As the connecting rod 310 vertically moves, the slide 312 vertically moves along the guide gibs 326. In the press device 300, the bolster 322 is arranged so as to face the slide 312. An upper die 303a is mounted as a part of the dies 303 to a surface of the slide 312 on a side facing the bolster 322 (a lower surface in the present embodiment). A lower die 303b that forms a pair with the upper die 303a is mounted as a part of the dies 303 to a surface of the bolster 322 on a side facing the slide 312 (an upper surface in the present embodiment).

The workpiece 120, which is the object to be processed, is placed between the upper die 303a and the lower die 303b, and pressed with the upper die 303a and the lower die 303b to perform the press processing (hereinafter simply referred to as “processing”) on the workpiece 120 by the press device 300. The workpiece 120 is conveyed, for example, from the left (upstream) side to the right (downstream) side in FIG. 2.

Specifically, the drive motor 304 rotates under the control of the controller 314. The rotation of the drive motor 304 is transmitted to the connecting rod 310 via the transmission mechanism 306 and the crankshaft 308 so that the slide 312 vertically moves. The upper die 303a and the lower die 303b are pressed by a downward movement of the slide 312, which performs the press processing of the workpiece 120. In other words, in the press device 300, the drive motor 304, the transmission mechanism 306, the crankshaft 308, the connecting rod 310, and the slide 312 constitute a press unit. The transmission mechanism 306 is provided with the rotary encoder 325 that is rotational speed detection means configured to detect a rotational speed of the crankshaft 308. The controller 314 can detect a position of the slide 312 by detecting the rotational speed of the crankshaft 308 by way of the rotary encoder 325. Additionally, the controller 314 can also detect an angle of the crankshaft 308 based on a detection result of the rotary encoder 325, functioning as angle detection means. Note that the angle detection means may include the rotary cam switch described above.

The sensor 324, which is load detection means configured to detect a load during the processing, is a sensor for detecting a load acting on the connecting rod 310 when the press device 300 performs the press processing to the workpiece 120. The sensor 324 is, for example, a load cell. The sensor 324 may be, for example, a strain gauge installed on the housing 302. The sensor 324 may be installed at any position on the connecting rod 310 (for example, at a position in a vicinity of a center thereof). Furthermore, a plurality of sensors 324 may be installed. For example, strains on the left and right of the housing 302 may be respectively detected, and results of detection may be added to obtain the total load. It should be noted that in FIG. 2, a side on which the display unit 316 is arranged is the front side of the press device 300.

The controller 314 controls the press device 300 in accordance with various programs stored in the storage unit 315. In the storage unit 315, a corresponding program (motion program) is stored for each die 303 used. The display unit 316 displays data that indicate a state of the press device 300. The input unit 318 is used to input data necessary to operate the press device 300. The input unit 318 is used when the user inputs parameters necessary for processing. The controller 314 controls the press device 300 and other devices of the press system 1 to work together in processing, while following the control by the line controller 10.

### <Robot>

FIG. 3 is an external perspective view showing a configuration of the robot 400 according to the present embodiment. The robot 400 included in the press system 1 is, for example, an articulated robot. The robot 400 includes a support base 410, a rotary part 420, a first arm 430, a second arm 440, a third arm 450, a hand 460, a control unit 470, and a storage unit 480.

The rotary part 420 can rotate in a direction of arrow Rt1. The first arm 430 is connected at one end to the rotary part 420 and at the other end to the second arm 440. The first arm 430 can rotate in a direction of arrow Rt2. The second arm 440 is connected at one end to the first arm 430 and at the other end to the third arm 450. The second arm 440 can rotate in a direction of arrow Rt3, and can also rotate in a direction of arrow Rt4.

The third arm 450 is connected at one end to the second arm 440 and at the other end to the hand 460. The third arm 450 can rotate in a direction of arrow Rt5, and can also rotate in a direction of arrow Rt6. The hand 460 is connected at one end to the third arm 450 and has a suction part 462 at the other end to suction the workpiece 120. The hand 460 can, for example, control an air pressure to suction the workpiece 120 and grip the workpiece 120, and release the suction of the workpiece 120 to release the workpiece 120. In addition, a state when the workpiece 120 is being suctioned is also expressed as suction ON, and a state when the suction is released is expressed as suction OFF.

A process of the robot Rm conveying the workpiece 120, which has been processed in the press device Pn, from the press device Pn is referred to as “unloading”. In addition, in order to process the workpiece 120 with the press device Pn+1, a process of the robot Rm conveying the workpiece 120 to the press device Pn+1 is referred to as “loading”. Furthermore, a series of movements in which the robot Rm starts operation from a predetermined position, unloads the workpiece 120 from the press device Pn, loads the workpiece 120 into the press device Pn+1, and then returns to the predetermined position is referred to as a “conveyance pattern”. The conveyance pattern is determined according to a shape of the workpiece 120, a shape of the dies 303, a type of processing, etc.

The control unit 470 controls a motor (not shown), a cylinder (not shown), air (not shown), etc., that the robot 400 has. This allows the control unit 470 to control the rotation in the direction of arrow Rt1 of the rotary part 420, the rotation in the direction of arrow Rt2 of the first arm 430, the rotation in the direction of arrow Rt3 and the rotation in the direction of arrow Rt4 of the second arm 440, and the rotation in the direction of arrow Rt5 and the rotation in the direction of arrow Rt6 of the third arm 450. By the control unit 470 performing such control, the hand 460 can move freely within a three-dimensional space. Additionally, by controlling these rotational speeds, the control unit 470 can also move the hand 460 at a predetermined speed, such as moving quickly or slowly within the three-dimensional space. Furthermore, the control unit 470 controls the gripping and the release of the gripping of the workpiece 120 by the hand 460.

In addition, the control unit 470 controls a position of the hand 460 in a reference three-dimensional coordinate system (for example, numerical values of x, y, z). The three-dimensional coordinates can be any system that specifies and controls a given position in a three-dimensional space, such as Cartesian coordinates, polar coordinates, or cylindrical coordinates. The control unit 470 is assumed to perform posture control and speed control of the robot 400 using known techniques.

In the storage unit 480, a predetermined spatial shape in a three-dimensional space, or a region of a predetermined surface shape in two dimensions (hereinafter simply referred to as a “region”) is defined, and information regarding the defined region is stored. The defined region is used to control the robot 400 so that the robot 400 does not interfere with other structures. For example, the defined region is a region set for the object gripped by the robot 400, specifically the workpiece 120, not to interfere with the press device 300 or a workpiece processed by another robot 400 or press device 300, or an object gripped by another robot 400. It should be noted that “interference” includes not only collisions and contacts but also situations where, even without actual contact, the positional relationship affects each other's movements. In general, it is possible to set multiple regions, for example, j regions (j≥1), in the storage unit 480 of the robot 400. In the present embodiment, ten (j≤10) regions are set and stored in the storage unit 480. Here, multiple regions are represented as a region C1, a region C2, . . . , a region Cj, . . . , a region C10, and when referred to collectively, they are simply expressed as the region Cj. Details on the configuration of the region Cj will be described later.

It should be noted that the gripping of the workpiece 120 by the hand 460 is performed by air suction, but the present invention is not limited thereto. For example, the hand 460 may have a claw portion, and the claw portion may be opened or closed to grip and release the workpiece 120. In this case, a fact that the workpiece 120 has been gripped, a fact of the release of the grip, etc., may be detected by a sensor provided in the claw part. Sensors, for example, various types of sensors such as optical and piezoelectric sensors, may be used.

Also, the robot 400 is assumed to return to a predetermined position in a predetermined posture before starting and after completing its operation normally. The predetermined posture and position are also referred to as a home position. The control unit 470 can set a three-dimensional coordinates when the robot 400 is in the home position as an origin (or fixed point).

### <Block Diagram>

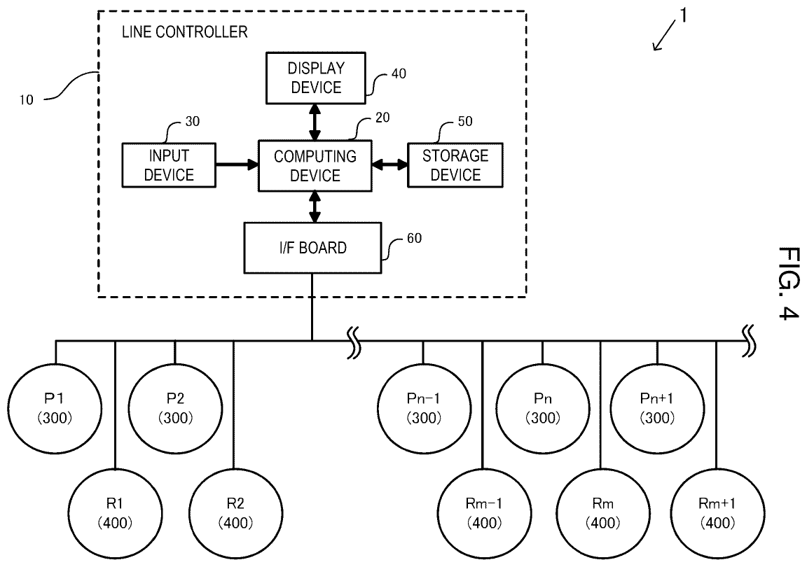

FIG. 4 is a block diagram of the press system 1 of the embodiment. The line controller 10 controls the entire press system 1 and includes a computing device 20, an input device 30, a display device 40, a storage device 50, and an interface (hereinafter referred to as I/F) board 60.

The computing device 20 controls the processing of the workpiece 120 by the press device 300 and the conveyance of the workpiece 120 by the robot 400 based on various signals described later received from the press device 300 and the robot 400 via the I/F board 60, and the region Cj. Various signals include timing signals output at each timing when the press device 300 is processing the workpiece 120, and timing signals output at each timing when the robot 400 is conveying the workpiece 120. The computing device 20 sends various internally generated signals to the press device 300 and the robot 400 via the I/F board 60. In addition, various calculations, various controls, various determinations, etc., performed by the computing device 20 are expressed in the following description as being performed by the line controller 10. The line controller 10, the press device 300, and the robot 400 are connected by wired or wireless communication means, or by hard wire, enabling sending and reception of the various signals.

The input device 30 is used for entering various types of information necessary for controlling the processing of the workpiece 120 by the press device 300 and the conveyance of the workpiece 120 by the robot 400. The display device 40 displays information about a state of the press system 1, information prompting an input of various settings of the press system 1, and other various information.

The storage device 50 is used to store various information necessary for controlling the processing of the workpiece 120 by the press device 300 and the conveyance of the workpiece 120 by the robot 400. The line controller 10 receives information about multiple regions Cj stored in the storage unit 480 of the robot 400 via the I/F board 60 in advance, before processing by the press system 1 begins, and stores it in the storage device 50.

### <About Various Signals>

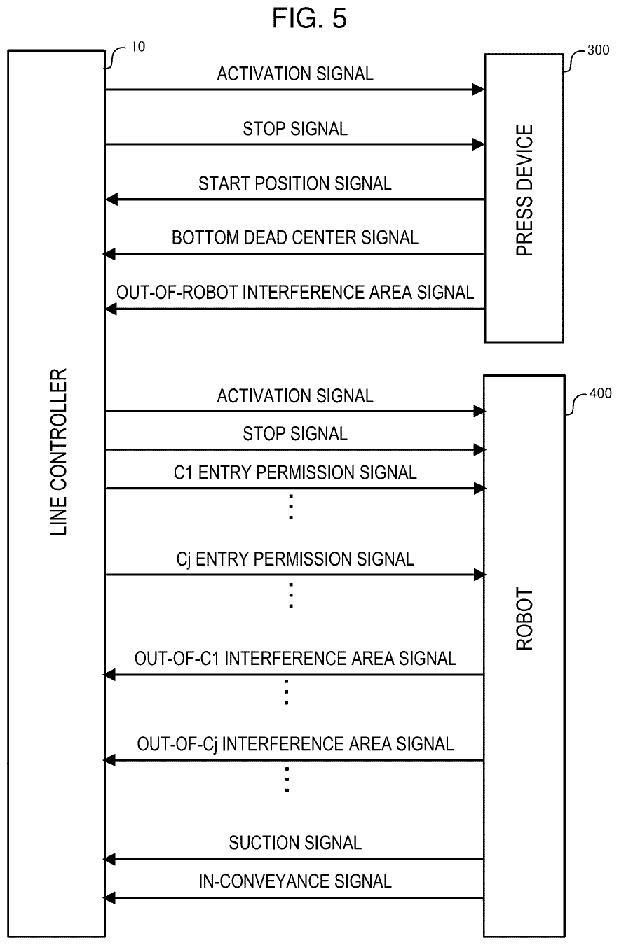

FIG. 5 is a diagram explaining the signals sent and received between each device in the embodiment.

(Signal Sent from Line Controller 10 to Press Device 300)

The line controller 10 sends an activation signal and a stop signal to the controller 314 of the press device 300. The activation signal is a signal to activate the press device 300, in other words, to start processing the workpiece 120. The stop signal is a signal for stopping the press device 300 in various situations, and includes, for example, an emergency stop signal, an on-the-spot stop signal, a cycle stop signal, and so on. The emergency stop signal is a signal used to stop by cutting off power from the drive motor, etc., after moving each device to a position where safety can be ensured. The on-the-spot stop signal is a signal to stop each device in a position where the signal was output (i.e., on the spot), and includes interlock of the press device 300, which will be described later. The cycle stop signal is a signal used to stop each device after completing one cycle of operation and returning to the home position during continuous operation. The stop signals are not limited to these, and there may be fewer or more.

(Signal Sent from Press Device 300 to Line Controller 10)

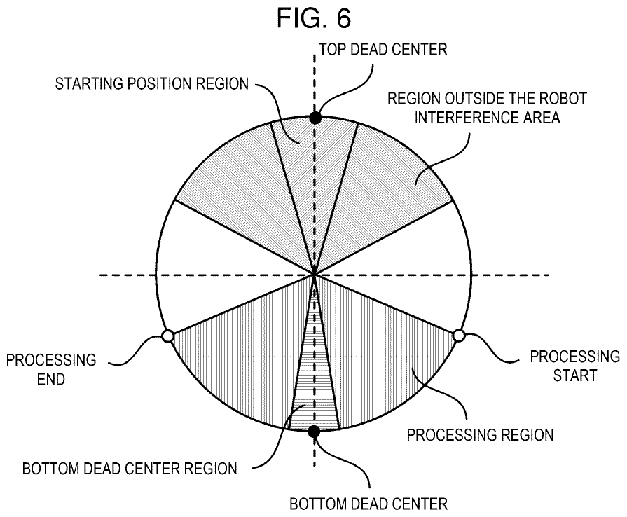

FIG. 6 is a diagram showing the relationship between the angle of the crankshaft 308 and the predetermined timing in each region and processing. In FIG. 6, a top dead center and a bottom dead center are indicated by black circles, and the start and end of processing are indicated by white circles. Also, a starting position region is indicated by a hatching of upward right diagonal lines, and a region outside a robot interference area is indicated by downward right diagonal lines. In addition, a part of the region outside the robot interference area also overlaps with the starting position region. Also, a bottom dead center region is indicated by a horizontal line and a processing region is indicated by a vertical line. It should be noted that a part of the processing region also overlaps with the bottom dead center region.

The controller 314 of the press device 300 sends a start position signal, a bottom dead center (lowest position) signal, and an out-of-robot interference area signal to the line controller 10 (press device side transmission step). The start position signal is a signal indicating a position of the slide 312 when processing begins, in other words, an angle of rotation of the crankshaft 308. The start position signal is turned ON, for example, in a range of 350 degrees to 10 degrees. The controller 314 of the press device 300 sends the start position signal to the line controller 10 when the angle of the crankshaft 308 reaches an angle to start processing. In addition, a starting position of the processing may be at the top dead center. The start position signal may be turned ON when, for example, the crankshaft 308 is at an angle corresponding to the start position, and turned OFF at other angles.

The bottom dead center signal is a signal indicating that the crankshaft 308 has reached the bottom dead center. The bottom dead center signal may be turned ON, for example, when the crankshaft 308 is at an angle corresponding to the bottom dead center, and turned OFF at other angles. The bottom dead center signal is turned ON, for example, in a range of 175 to 185 degrees.

The out-of-robot interference area signal is a signal indicating that the press device 300 is outside an area of interference with the robot 400. The processing of the press device 300 is set by a program, and the angle of the crankshaft 308 at which processing starts (hereinafter referred to as a “processing start angle”) and the angle of the crankshaft 308 at which processing ends (hereinafter referred to as a “processing end angle”) are set in advance. The range from the processing start angle to the processing end angle is referred to as a “processing angle” (or a “processing region”). The processing angle is, for example, 90 degrees to 270 degrees, 120 degrees to 240 degrees, etc. Since processing is being performed on the workpiece 120 by the press device 300 within the processing angle, the robot 400 cannot enter the region of the press device 300. Also, if there is not at least a space equal to or greater than the height of the hand 460 and the workpiece 120 between the lower die 303b and the upper die 303a, the hand 460 cannot enter the dies. As mentioned above, the controller 314 of the press device 300 detects the angle of the crankshaft 308 and sends the out-of-robot interference area signal based on the detected angle. The out-of-robot interference area signal may be turned ON when, for example, the crankshaft 308 is within the robot interference area (for example, 60 degrees to 300 degrees), and turned OFF when the crankshaft 308 is outside the robot interference area (for example, 300 degrees to 60 degrees).

(Signal Sent from Line Controller 10 to Robot 400)

The line controller 10 sends an activation signal, a stop signal, a C1 entry permission signal, . . . , a Cj entry permission signal, . . . to the control unit 470 of the robot 400 (control means side transmission step). The activation signal is a signal to activate the robot 400, in other words, to start the conveyance of the workpiece 120. The stop signal is a signal to stop the robot 400 in various situations, and includes, for example, an emergency stop signal, an immediate stop signal, a cycle stop signal, etc. It should be noted that the stop signal is the same as the stop signal of the press device 300, and the explanation is omitted.

The C1 entry permission signal, . . . , the Cj entry permission signal, . . . are signals corresponding to regions C1, . . . , Cj, . . . and in the present embodiment, there are 10 signals (1≤j≤10). The Cj entry permission signal is a signal indicating whether to permit the robot 400 to enter the region Cj, which will be described later, and, for example, may be turned ON when entry to the region Cj is permitted and turned OFF when the entry is prohibited. The line controller 10 sets ON or OFF for all of the C1 entry permission signal, . . . , the Cj entry permission signal, . . . , based on the signals input from the press device 300 and the robot 400, and outputs the signals to the robot 400.

(Signal Sent from Robot 400 to Line Controller 10)

The control unit 470 of the robot 400 sends an out-of-C1 interference area signal, . . . an out-of-Cj interference area signal, . . . , a suction signal, and an in-conveyance signal to the line controller 10 (conveyance device-side transmission step). The control unit 470 of the robot 400 can determine whether the hand 460 is outside the region Cj based on the multiple regions Cj stored in the storage unit 480 of the robot 400 and the coordinates of the hand 460. The control unit 470 of the robot 400 sends the out-of-Cj interference area signal depending on whether the hand 460 is outside the region Cj. The out-of-Cj interference area signal may be turned ON (outside the interference area) when, for example, the hand 460 is outside the region Cj, and turned OFF (inside the interference area) when the hand is inside the region Cj. In the relation between the interference area and the hand 460, the interference area is a region to prevent the workpiece 120 from interfering with the dies 303 mounted on the press device 300, other workpieces, or other robots 400. Therefore, the area changes depending on the size of the workpiece 120 being processed, and the operable region of the hand 460 holding the workpiece 120 also changes depending on the size of the workpiece.

The suction signal is a signal indicating that the hand 460 of the robot 400 is suctioning and gripping the workpiece 120, and, for example, may be turned ON when the workpiece 120 is suctioned and turned OFF when the workpiece is not suctioned. The in-conveyance signal indicates that the hand 460 of the robot 400 has suctioned the workpiece 120 and has not released the suction, in other words, it is holding and conveying the workpiece 120. The in-conveyance signal may be turned ON when, for example, the workpiece 120 is being conveyed, and turned OFF when the workpiece is not being conveyed.

### <Setting of Multiple Regions>

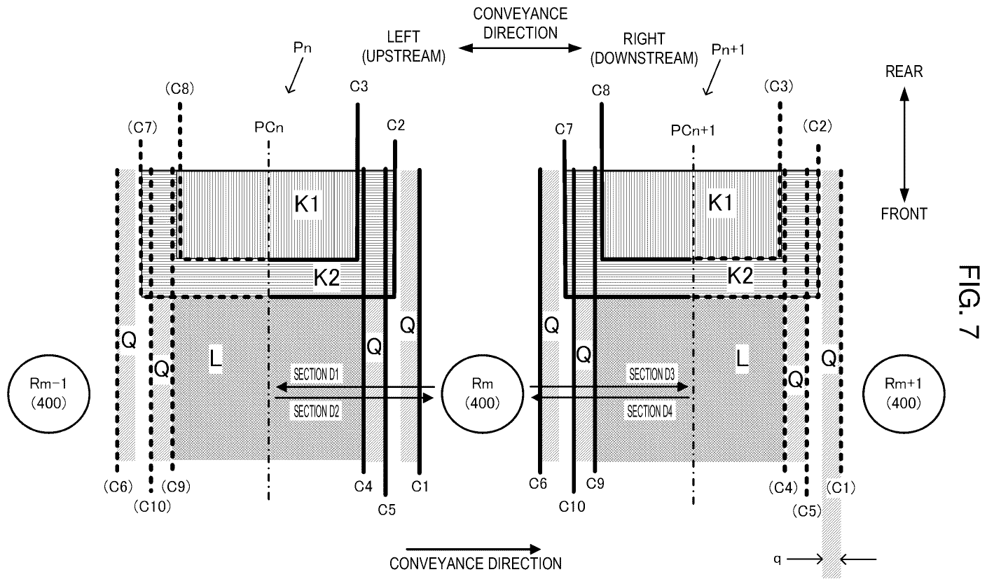

FIG. 7 is a diagram explaining the region of the embodiment and is a schematic view of a part of the press system 1 seen from above. FIG. 7 also shows the conveyance direction and the front-rear direction. In FIG. 7, the press system 1 is disposed in the order of the robot Rm−1, the press device Pn, the robot Rm, the press device Pn+1, and the robot Rm+1 from the upstream side in the conveyance direction of the workpiece 120. This section describes the region Cj, which is set for the conveyance control of the robot Rm. For this reason, from the perspective of the robot Rm, the press device Pn can be considered the front press device, and the press device Pn+1 can be considered the rear press device.

In the present embodiment, in order to control the conveyance of the robot Rm that conveys the workpiece 120 during processing by the press device 300, ten regions C1 to C10 are set. The regions C1 to C5 are the regions set to avoid interference between the robot Rm and the upstream device, namely the press device Pn or the robot Rm−1. The regions C6 to C10 are regions set to avoid interference between the robot Rm and the downstream device, namely, the press device Pn+1 or the robot Rm+1.

In addition, the ten regions C1 to C10 include regions restricted by the specifications of the press device 300 and regions restricted by the specifications of the robot 400. For example, when processing the workpiece 120 with the press device 300, dies 303 of various sizes are used, and the region Cj includes regions set according to the size of the die 303. The controller 314 of the press device may detect the size of the dies 303 based on input from the display unit 316 of the press device 300. The controller 314 may also include means for the press device 300 to detect the size of the dies 303, and may detect the size of the dies 303 based on the detection result.

The operation of the robot 400 is limited according to the size of the dies 303 mounted on the press device 300. For example, when small dies 303 are used, even if the hand 460 of the robot 400 can enter a predetermined position, when large dies 303 are used, the hand 460 may not be able to enter the same predetermined position. In FIG. 7, the region corresponding to the smallest dies 303 among the dies 303 used in the press device 300 is shown with vertical line hatching as a die interference area K1. Also, the largest dies 303 among the dies 303 used in the press device 300, in other words, the region corresponding to the size of the slide 312, is indicated by horizontal hatching as a die interference area K2. In FIG. 7, the die interference area K2 partially overlaps with the die interference area K1, but is a region that also includes the die interference area K1. In cases where it is not necessary to particularly distinguish between K1 and K2, the area is referred to as a “die interference area K”.

In FIG. 7, the region provided to avoid interference between the robots 400 according to the range of motion of the robots 400 is shown with diamond lattice hatching as a robot interference area L. The robot interference area L is provided not only to avoid interference between the robots 400, but also to prevent collisions between the robot 400 and the workpiece 120. Even if the length of the die interference area K1 in the conveyance direction is shorter than the length of the robot interference area L in the conveyance direction, the robot interference area L cannot be shortened any further and is an area that does not depend on the size of the dies 303.

A portion Q indicated by the upward right diagonal hatching in FIG. 7 is a part corresponding to the distance (or time) required for the robot Rm to actually stop after receiving the stop signal. The portion Q is provided with, for example, a width q in the conveyance direction. The portion Q is set based on the movement speed of the robot Rm and the time from receiving the stop signal to the stopping of the robot Rm, etc., in other words, the operation of the robot Rm.

Based on the above, the storage unit 480 of the robot Rm is configured with the regions C1 to C10 as follows.

### [Region C1 as First Region]

This is a region set so that the robot Rm does not interfere with the slide 312 of the press device Pn, and based on the die interference area K2 and the portion Q of the press device Pn, set as a surface (wall) intersecting the conveyance direction when viewed from above.

### [Region C2 as Second Region]

This is a region set so that the robot Rm does not interfere with the dies 303 of the press device Pn, and based on the die interference area K2 of the press device Pn, set as a surface (wall) intersecting the conveyance direction and a surface (wall) parallel to the conveyance direction when viewed from above. The region C2 is a region set to correspond to the case where the dies 303 have the largest size, that is, the size of the slide 312.

### [Region C3 as Second Region]

This is a region set so that the robot Rm does not interfere with the dies 303 of the press device Pn, and based on the die interference area K1 of the press device Pn, set as a surface (wall) intersecting the conveyance direction and a surface (wall) parallel to the conveyance direction when viewed from above. The region C3 is a region that is set to correspond to the case where the dies 303 have a small size. Either the region C2 or the region C3 is used depending on the size of the dies 303.

### [Region C4 as Third Region]

This is a region set so that the robot Rm and the robot Rm−1 do not interfere with each other, and based on the robot interference area L between the robot Rm and the robot Rm−1, set as a surface (wall) intersecting the conveyance direction when viewed from above.

### [Region C5 as First Region]

This is a region set so that the robot Rm does not interfere with the slide 312 of the press device Pn, and based on the die interference area K1 and the portion Q of the press device Pn, set as a surface (wall) intersecting the conveyance direction when viewed from above. Either the region C1 or the region C5 is used depending on the size of the dies 303.

### [Region C6 as Fourth Region]

This is a region set so that the robot Rm does not interfere with the slide 312 of the press device Pn+1, and based on the die interference area K2 and the portion Q of the press device Pn+1, set as a surface (wall) intersecting the conveyance direction when viewed from above. Also, the region C6 is a region that is symmetrical to the region C1 with respect to the center PCn (or PCn+1) indicated by a one-dot chain line in the conveyance direction of the press device Pn (or Pn+1).

### [Region C7 as Fifth Region]

This is a region set so that the robot Rm does not interfere with the dies 303 of the press device Pn+1, and based on the die interference area K2 of the press device Pn+1, set as a surface (wall) intersecting the conveyance direction and a surface (wall) parallel to the conveyance direction when viewed from above. The region C7 is a region set to correspond to the case where the dies 303 have the largest size, that is, the size of the slide 312. Also, the region C7 is a region that is symmetrical to the region C2 with respect to the center PCn (or PCn+1) in the conveyance direction of the press device Pn (or Pn+1).

### [Region C8 as Fifth Region]

This is a region set so that the robot Rm does not interfere with the dies 303 of the press device Pn+1, and based on the die interference area K1 of the press device Pn+1, set as a surface (wall) intersecting the conveyance direction and a surface (wall) parallel to the conveyance direction when viewed from above. The region C8 is a region that is set to correspond to the case where the dies 303 have a small size. Also, the region C8 is a region that is symmetrical to the region C3 with respect to the center PCn (or PCn+1) in the conveyance direction of the press device Pn (or Pn+1). Either the region C7 or the region C8 is used depending on the size of the dies 303.

### [Region C9 as Sixth Region]

This is a region set so that the robot Rm and the robot Rm+1 do not interfere with each other, and based on the robot interference area L between the robot Rm and the robot Rm+1, set as a surface (wall) intersecting the conveyance direction when viewed from above. Also, the region C9 is a region that is symmetrical to the region C4 with respect to the center PCn (or PCn+1) in the conveyance direction of the press device Pn (or Pn+1).

### [Region C10 as Fourth Region]

This is a region set so that the robot Rm does not interfere with the slide 312 of the press device Pn+1, and based on the die interference area K1 and the portion Q of the press device Pn+1, set as a surface (wall) intersecting the conveyance direction when viewed from above. Also, the region C10 is a region that is symmetrical to the region C5 with respect to the center PCn (or PCn+1) in the conveyance direction of the press device Pn (or Pn+1). Either the region C6 or the region C10 is used depending on the size of the dies 303.

In summary, the regions C1 and C5 correspond to the first region, the regions C2 and C3 correspond to the second region, and the region C4 corresponds to the third region. The regions C6 and C10 correspond to the fourth region, the regions C7 and C8 correspond to the fifth region, and the region C9 corresponds to the sixth region. In addition, the out-of-C1 interference area signal and the out-of-C5 interference area signal correspond to the out-of-first region signal corresponding to the first region. The out-of-C2 interference area signal and the out-of-C3 interference area signal correspond to the out-of-second region signal corresponding to the second region. The out-of-C4 interference area signal corresponds to the out-of-third region signal corresponding to the third region. The out-of-C6 interference area signal and the out-of-C10 interference area signal correspond to the out-of-fourth region signal corresponding to the fourth region. The out-of-C7 interference area signal and the out-of-C8 interference area signal correspond to the out-of-fifth region signal corresponding to the fifth region. The out-of-C9 interference area signal corresponds to the out-of-sixth region signal corresponding to the sixth region.

In FIG. 7, the regions C1 to C10 stored in the storage unit 480 of the robot Rm are shown with solid lines. In addition, the regions C6 to C10 indicated by broken lines in the press device Pn are regions stored in the storage unit 480 of the robot Rm−1. Also, the regions C1 to C5 indicated by broken lines in the press device Pn+1 are regions stored in the storage unit 480 of the robot Rm+1.

### <Sections of Conveyance Route of Robot Rm>

For use in predetermined conditions described later, which is set in the region Cj, the following sections D1 to D4 are defined regarding a state in a path during the conveyance by the robot Rm (hereinafter also referred to as a conveyance route). In practice, the robot Rm draws an efficient and free conveyance route to load and unload the workpiece 120, but for simplicity, in FIG. 7, a section of the robot Rm is illustrated parallel to the conveyance direction. The line controller 10 determines which section the robot Rm is in based on the suction signal and the in-conveyance signal sent from the robot Rm.
[Section D1] A section in which the robot Rm moves with the suction turned ON (going to pick up the workpiece 120) in order to unload the processed workpiece 120 from the press device Pn
[Section D2] A section in which the robot Rm is suctioning the processed workpiece 120 and unloading the workpiece 120 from the press device Pn (during conveyance)
[Section D3] A section in which the robot Rm is suctioning the workpiece 120 and loading the workpiece 120 to the press device Pn+1 for the next processing (during conveyance)
[Section D4] A section in which, after loading the workpiece 120 into the press device Pn+1, the robot Rm turns OFF the suction and returns to the home position

### <Entry Conditions for Multiple Regions>

In the region Cj, the predetermined conditions are set. The line controller 10 prohibits the robot 400, specifically the hand 460, from entering beyond the region Cj as long as the predetermined conditions are not met. In other words, the line controller 10 interlocks to prevent the robot 400 from operating if the predetermined conditions are not met. Interlock refers to a mechanism where, for example, an electric lock does not unlock as long as the predetermined conditions are not met. On the other hand, the line controller 10 allows the robot 400, specifically the hand 460, to enter beyond the region Cj when the predetermined conditions are met.

The line controller 10 controls the permission or prohibition of the robot Rm entering the region Cj by sending the Cj entry permission signal to the robot Rm. From the perspective of the robot 400, there is a wall in a travel direction (entry direction), and it cannot break through that wall until the predetermined conditions are met. Once the predetermined conditions are met, it can enter beyond the wall. In the following description, the interference of the robot Rm's hand 460 is simply expressed as the interference of the robot Rm.

### [Entry Conditions for Region C1]

Entry to the region C1 is permitted when the following conditions are met.
Condition C1-1: Robot Rm−1 is outside region C9
Condition C1-2: Workpiece 120 is inside press device Pn
   Except when the robot Rm is located in the section D2. This is because when the robot Rm is in the section D2, there is no workpiece 120 on the press device Pn due to the unloading operation of the robot Rm itself, and the condition C1-2 is not satisfied.

### [Entry Conditions for Region C2]

Entry to the region C2 is permitted when the following conditions are met.
Condition C2-1: Robot Rm−1 is outside region C9
Condition C2-2: Press device Pn is outside robot interference area
Condition C2-3: Processed workpiece 120 is inside press device Pn
   Except when the robot Rm is located in the section D2. This is similar to excluding the section D2 in the region C1, and the same applies below.

### [Entry Conditions for Region C3]

Entry to the region C3 is permitted when the following conditions are met.
Condition C3-1: Robot Rm−1 is outside region C9
Condition C3-2: Press device Pn is outside robot interference area
Condition C3-3: Processed workpiece 120 is inside press device Pn
   Except when the robot Rm is located in the section D2.

### [Entry Condition for Region C4]

Entry to the region C4 is permitted when the following condition is met.
Condition C4-1: Robot Rm−1 is outside region C9

### [Entry Conditions for Region C5]

Entry to the region C5 is permitted when the following conditions are met.
Condition C5-1: Robot Rm−1 is outside region C9 described later
Condition C5-2: Workpiece 120 is inside press device Pn
   Except when the robot Rm is located in the section D2.

### [Entry Conditions for Region C6]

Entry to the region C6 is permitted when the following conditions are met.
Condition C6-1: Robot Rm+1 is outside region C4
Condition C6-2: Workpiece 120 is not inside press device Pn+1
   Except when the robot Rm is located in the section D4.

### [Entry Conditions for Region C7]

Entry to the region C7 is permitted when the following conditions are met.
Condition C7-1: Robot Rm+1 is outside region C4
Condition C7-2: Press device Pn+1 is outside robot interference area
Condition C7-3: Workpiece 120 is not inside press device Pn+1
   Except when the Robot Rm is Located in the Section D4.

### [Entry Conditions for Region C8]

Entry to the region C8 is permitted when the following conditions are met.
Condition C8-1: Robot Rm+1 is outside region C4
Condition C8-2: Press device Pn+1 is outside robot interference area
Condition C8-3: Workpiece 120 is not inside press device Pn+1
   Except when the robot Rm is located in the section D4.

### [Entry Condition for Region C9]

Entry to the region C9 is permitted when the following condition is met.
Condition C9-1: Robot Rm+1 is outside region C4

### [Entry Conditions for Region C10]

Entry to the region C10 is permitted when the following conditions are met.
Condition C10-1: Robot Rm+1 is outside region C4
Condition C10-2: Workpiece 120 is not inside press device Pn+1
   Except when the robot Rm is located in the section D4.

### <State of Workpiece>

In the conditions C1-2 and C5-2 of the region Cj, there is a condition that the workpiece 120 is inside the press device Pn. In addition, in the conditions C2-3 and C3-3, there is a condition that the processed workpiece 120 is inside the press device Pn, and in the conditions C6-2, C7-3, C8-3, and C10-2, there is a condition that the workpiece 120 is not inside the press device Pn+1. The line controller 10 determines a state of the workpiece 120 as “workpiece present”, “no workpiece”, or “processed workpiece present” in the following manner.

The line controller 10 determines “workpiece present” in the press device Pn when it receives the suction signal OFF from the robot Rm−1 within the die interference area K. The line controller 10 determines “no workpiece” in the press device Pn+1 when it receives suction signal ON from the robot Rm+1 within the die interference area K. The line controller 10 determines “processed workpiece present” in the press devices Pn and Pn+1 when it receives the bottom dead center signal ON from the press devices Pn and Pn+1.

### <Interlock of Press Device>

In the present embodiment, it is also possible for the line controller 10 to control the permission or prohibition of processing by the press device 300 using the region Cj. That is, depending on a state of the robot 400, it is possible to permit or prohibit entry to the processing angle of the crankshaft 308. In other words, the line controller 10 interlocks to prevent the press device 300 from operating if predetermined conditions are not met. The line controller 10 determines whether to permit or prohibit the processing of the press device 300 according to the size of the dies 303 under the following conditions. Explanation will be given through relationships between the press device Pn and the front robot Rm−1, and between the press device Pn and the rear robot Rm.

### (In Case of Small-Sized Dies)

Condition S1-1: Robot Rm−1 is outside region C8
Condition S1-2: Robot Rm is outside region C3

### (in Case of Large-Sized Dies)

Condition S2-1: Robot Rm−1 is outside region C7
Condition S2-2: Robot Rm is outside region C2

The line controller 10 allows processing by the press device Pn when both conditions S1-1 and S1-2 are met, or when both conditions S2-1 and S2-2 are met. The line controller 10 may pause the processing operation of the press device Pn by the stop signal described in FIG. 5 while processing is prohibited. The pause position can be anywhere outside the robot interference area, regardless of the start position range (see FIG. 6). Additionally, a processing permission signal, etc., may be provided separately so that the processing permission signal, etc., is ON for permission and OFF for prohibition, and the press device Pn may pause, etc., based on the processing permission signal.

### <Conveyance Control of Robot Rm>

The line controller 10 receives the start position signal, bottom dead center signal, and out-of-robot interference area signal, which were explained in FIG. 5, from all the press devices 300 at predetermined time intervals from when the press system 1 starts continuous operation until it ends continuous operation. Similarly, the line controller 10 receives the out-of-Cj interference area signal, the suction signal, and the in-conveyance signal described in FIG. 5 from all robots 400 at predetermined time intervals from when the press system 1 starts continuous operation until it ends continuous operation. Furthermore, the line controller 10 sends the Cj entry permission signal, explained in FIG. 5, to all robots 400 at predetermined time intervals from when the press system 1 starts continuous operation until it ends continuous operation.

In this way, the line controller 10 receives various signals from all the press devices 300 and all the robots 400 that make up the press system 1. And the line controller 10 determines whether to prohibit or permit entry to the region Cj of all robots 400, and sends an out-of-Cj interference area signal to all robots 400. Also, as mentioned above, it is possible to interlock the press device 300. In the present embodiment, the line controller 10 performs centralized management in this manner. Therefore, the press device 300 can focus on the processing control of the workpiece 120, and the robot 400 can focus on the conveyance control of the workpiece 120. The determination on whether entry to the region Cj is possible is made centrally by the line controller 10, and the robot 400 enters beyond the region Cj where permission is granted if the permission is granted based on the Cj entry permission signal received from the line controller 10. By having the line controller 10 perform centralized management, it is possible to eliminate the critical path, or at least reduce the required time, in the processing step and the conveyance step of the entire press system 1.

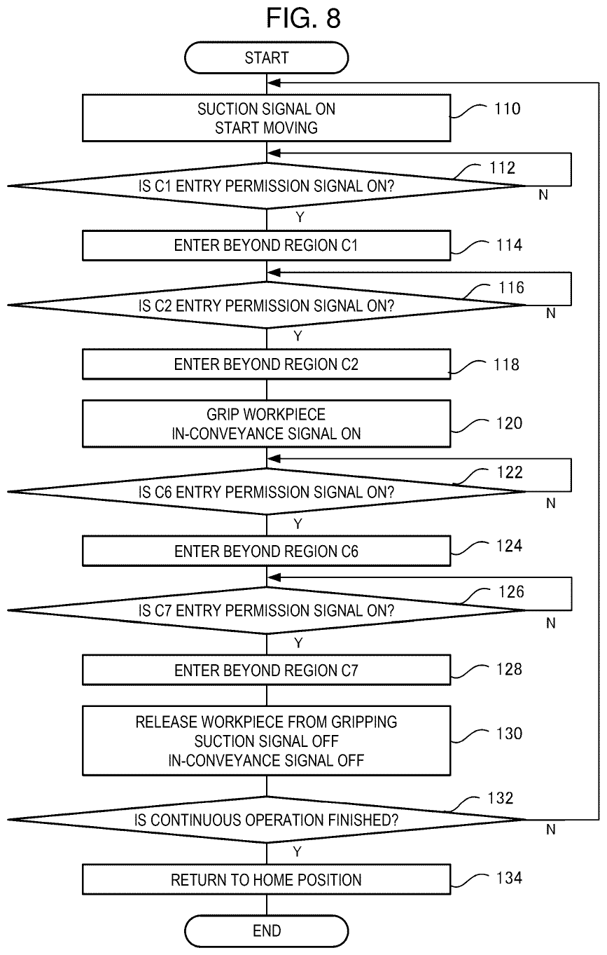

Based on the above, the operation will be explained from when the robot Rm starts operation from the home position, unloads the workpiece 120 from the press device Pn, loads the workpiece 120 into the press device Pn+1, and to when the robot Rm returns to the home position. FIG. 8 is a flowchart explaining the conveyance control of the robot Rm in the present embodiment as the control of the control unit 470 on the robot Rm side. In the description of FIG. 8, large dies 303 are mounted on the press devices Pn, Pn+1, and the permission or prohibition of entry is determined for the region C1, the region C2, the region C6, and the region C7. Also, for the region C4 and the region C9, the permission or prohibition of entry is always determined, regardless of the size of the dies 303. In cases where small dies 303 are mounted, the region C5, the region C3, the region C10, and the region C8 may be used instead of the region C1, the region C2, the region C6, and the region C7.

When the activation signal is input from the line controller 10, the control unit 470 of the robot Rm starts the processing from step (hereinafter referred to as S) 110 onward. In S110, the control unit 470 starts the suction of the hand 460, turns the suction signal ON, the in-conveyance signal OFF, and starts the movement of the hand 460 to load the workpiece 120 into the press device Pn. In S112, the control unit 470 determines whether the C1 entry permission signal sent from the line controller 10 is ON (permitted). In S112, if the C1 entry permission signal is determined to be OFF, the control unit 470 pauses movement and returns the processing to S112, and if the C1 entry permission signal is determined to be ON, the control unit 470 proceeds the processing to S114. In S114, the control unit 470 causes the hand 460 to enter beyond the region C1.

In S116, the control unit 470 determines whether the C2 entry permission signal sent from the line controller 10 is ON (permitted). In S116, if the C2 entry permission signal is determined to be OFF, the control unit 470 pauses movement and returns the processing to S116, and if the C2 entry permission signal is determined to be ON, the control unit 470 proceeds the processing to S118. In S118, the control unit 470 causes the hand 460 to enter beyond the region C2. In S120, the control unit 470 grips the processed workpiece 120 of the press device Pn with the hand 460, turns the in-conveyance signal ON, and moves to load the workpiece 120 into the press device Pn+1.

In S122, the control unit 470 determines whether the C6 entry permission signal sent from the line controller 10 is ON (permitted). In S122, if the C6 entry permission signal is determined to be OFF, the control unit 470 pauses movement and returns the processing to S122, and if the C6 entry permission signal is determined to be ON, the control unit 470 proceeds the processing to S124. In S124, the control unit 470 causes the hand 460 to enter beyond the region C6.

In S126, the control unit 470 determines whether the C7 entry permission signal sent from the line controller 10 is ON (permitted). In S126, if the C7 entry permission signal is determined to be OFF, the control unit 470 pauses movement and returns the processing to S126, and if the C7 entry permission signal is determined to be ON, the control unit 470 proceeds the processing to S128. In S128, the control unit 470 causes the hand 460 to enter beyond the region C7. In S130, the control unit 470 loads the workpiece 120 into the press device Pn+1, releases the grip by the hand 460, turns the suction signal OFF, and turns the in-conveyance signal OFF.

In S132, the control unit 470 determines whether to end continuous operation. For example, the control unit 470 may determine to end continuous operation when it receives the stop signal from the line controller 10. In S132, if the control unit 470 determines to continue continuous operation, the control unit 470 returns the processing to S110, and if the control unit 470 determines to end continuous operation, the control unit 470 proceeds the processing to S134. In S134, the control unit 470 returns the robot Rm to the home position and ends the processing.

In FIG. 8, it is explained as if the determination processing of S112, S116, S122, and S126 are carried out in order. However, the control unit 470 of the robot Rm may perform the determination processing of S112, S116, S122, and S126 at the same timing, and may enter beyond the permitted region Cj, while waiting in front of the non-permitted region Cj.

As described above, by the line controller 10 sending the out-of-Cj interference area signal to the robot Rm, it is possible to enter beyond the region Cj where entry is permitted. Also, the robot 400 can be kept on standby as close as possible to the region Cj, where entry is not permitted. This allows the time required for the robot 400 to load and unload the workpiece 120 to be shortened, thereby improving the productivity of the press system 1 while avoiding interference between devices. In addition, since there are regions set according to the dies in the region Cj, the conveyance of workpiece 120 by the hand 460 of the robot 400 is applicable not only when it is from the side of the dies 303, but also when it is from the front of the dies 303. Furthermore, in the present embodiment, it is not necessary to conduct a simulation of the conveyance pattern in advance or to perform multiple trials with the actual machine.

In the above embodiment, the interlock is applied to the robot 400 by combining the permission to enter multiple regions Cj (spaces set to prevent collisions between devices) stored in the storage unit 480 of the robot 400, the state of the workpiece 120, and the state of the press device 300. This allows each device of the press system 1 to automatically create a highly productive conveyance timing without colliding with each other, even if the conveyance trajectory of the workpiece 120 by the robot 400 changes, from the first operation of continuous operation.

As described above, according to the present embodiment, it is possible to provide the press system and the method for controlling the press system that can easily avoid collisions and improve productivity regardless of the workpiece conveyance pattern by a workpiece conveyance device.

Although the preferred embodiment of the present invention has been described above, the present invention is not limited to the preferred embodiment, and various modifications and changes are possible within the scope of the summary, such as the following modifications and gist, for example.
The press system described above is configured with an articulated robot as a workpiece conveyance device, but the present invention is not limited thereto. For example, the press system can also be applied to configurations where the workpiece is conveyed by a horizontal feeder, rather than an articulated type.
In the above-described embodiment, the line controller 10 performs the conveyance control of the robot 400 using multiple regions defined in the robot, but the present invention is not limited thereto. In addition to the regions stored in the robot, multiple regions are defined in the storage device 50 of the line controller 10, and the multiple regions stored in the storage device may be used for the conveyance control of the robot.
The ON and OFF of various signals in the above-described embodiment may be reversed. That is, for example, when the hand is suctioning the work, it is turned ON, but conversely, it may be turned OFF, and when it is not suctioning, it is turned OFF, but conversely, it may be turned ON. The same applies to other signals.
In each stage of loading and unloading by the robot, the presence or absence of the workpieces may be detected using other sensors.
Regarding the workpiece conveyance direction, in FIG. 1, it is conveyed from left to right, but it is also possible to apply the configuration of the above-mentioned embodiment even if it is conveyed from right to left.
In the above-described embodiment, the configuration regarding the die size is such that two sizes can be employed: large sized dies; and small sized dies, but the present invention is not limited thereto. It is also possible to set regions for single size dies or dies of three or more sizes. In addition, for the single size dies, it is necessary to set a total of four regions: two regions (for example, C1 and C2) for the front device and two regions (for example, C6 and C7) for the rear device. For this reason, how many different sizes of the dies can be accommodated, or in other words, the upper limit of the number of regions that can be set will depend on the upper limit of the number of regions that can be set by the robot.
In FIG. 7, the region is defined in the left-right direction (conveyance direction) and the front-back direction, but the present invention is not limited thereto. Furthermore, the vertical direction may also be defined, whereby a three-dimensional region may be defined. It may also be defined as a two-dimensional region such as the left-right direction and the vertical direction, or the front-back direction and the vertical direction.
The robot's control unit controls the robot's posture, movement, speed of movement, etc., i.e., coordinates and speed, using three-dimensional coordinates, but the present invention is not limited thereto. For example, it may be equipped with an imaging unit that captures images of the robot from the outside, and by analyzing the images captured by the imaging unit, it may control the robot's posture, movement, speed of movement, etc., in other words, coordinates and speed.
In the above-mentioned embodiment, an independent line controller from the press device and the robot determines whether to permit or prohibit entry to the region Cj, but the present invention is not limited thereto. The controller of the predetermined press device may function as the line controller, and the control unit of the predetermined robot may also function as the line controller.

### REFERENCE SIGNS LIST

1 Press system
10 Line controller
20 Computing device
30 Input device
40 Display device
50 Storage device
100 Lifter
120 Workpiece
200 Horizontal feeder
210, 220 Hand
230 Table
240 Arm
300 Press device
302 Housing
303 Die, 303a Upper die, 303b Lower die
304 Drive motor
306 Transmission mechanism
308 Crankshaft
310 Connecting rod
312 Slide
314 Controller
315 Storage unit
316 Display unit
318 Input unit
322 Bolster
324 Sensor
325 Rotary encoder
326 Guide gib
400 Robot
410 Support base
420 Rotary part
460 Hand
462 Suction part
470 Control unit
480 Storage unit
C1, C2, C3, C4, C5, C6, C7, C8, C9, C10, Cj Region
D1, D2, D3, D4 Section
K, K1, K2 Die interference area
L Robot interference area
P1, P2, . . . , Pn, Pn+1, . . . . Press device
Q Portion
R1, R2, . . . , Rm−1, Rm, Rm+1, . . . . Robot
q Width

1. A press system comprising:
a press device including a crankshaft and a slide configured to move up and down according to rotation of the crankshaft, the press device being configured to process a workpiece with dies mounted on the slide;
a conveyance device configured to perform loading of the workpiece into the press device or unloading of the workpiece from the press device, and convey the workpiece; and
control means configured to control the press device and the conveyance device,
in which the press system further includes:
a predetermined conveyance device;
a front press device disposed on an upstream side in a conveyance direction of the workpiece with respect to the predetermined conveyance device;
a rear press device disposed on a downstream side in the conveyance direction with respect to the predetermined conveyance device;
a front conveyance device disposed on the upstream side in the conveyance direction with respect to the predetermined conveyance device;
a rear conveyance device disposed on the downstream side in the conveyance direction with respect to the predetermined conveyance device; and
a storage unit configured to store information on multiple regions set to avoid interference between the predetermined conveyance device and the front press device, interference between the predetermined conveyance device and the rear press device, interference between the predetermined conveyance device and the front conveyance device, and interference between the predetermined conveyance device and the rear conveyance device,
the front press device and the rear press device each send a signal corresponding to an angle of the crankshaft to the control means,
the predetermined conveyance device, the front conveyance device, and the rear conveyance device each send a signal corresponding to a state of conveyance of the workpiece to the control means,
the control means determines whether to permit entry to each of the multiple regions for each of the multiple regions based on signals corresponding to the angle of the crankshaft sent from the front press device and the rear press device, as well as signals corresponding to the state of conveyance of the workpiece sent from the predetermined conveyance device, the front conveyance device, and the rear conveyance device, and sends an entry permission signal for each of the multiple regions to the predetermined conveyance device based on determined results, and
the predetermined conveyance device performs the loading or the unloading based on the entry permission signal.

2. The press system according to claim 1, wherein the multiple regions include a first region, a second region, a third region, a fourth region, a fifth region, and a sixth region,
the first region being a region set based on a size of the dies of the front press device and an operation of the predetermined conveyance device, to avoid interference between the predetermined conveyance device and the slide of the front press device,
the second region being a region set based on the size of the dies of the front press device to avoid interference between the predetermined conveyance device and the dies of the front press device,
the third region being a region set based on operations of the predetermined conveyance device and the front conveyance device to avoid interference between the predetermined conveyance device and the front conveyance device,
the fourth region being a region set based on a size of the dies of the rear press device and the operation of the predetermined conveyance device, to avoid interference between the predetermined conveyance device and the slide of the rear press device,
the fifth region being a region set based on the size of the dies of the rear press device to avoid interference between the predetermined conveyance device and the dies of the rear press device,
the sixth region being a region set based on operations of the predetermined conveyance device and the rear conveyance device to avoid interference between the predetermined conveyance device and the rear conveyance device.

3. The press system according to claim 2, wherein in the fifth region, when the predetermined conveyance device is replaced with the front conveyance device and the rear press device is replaced with the front press device,
the control means permits entry of the front conveyance device into a processing angle, which is an angle of the crankshaft from start to end of the processing by the front press device, when the front conveyance device is outside the fifth region and the predetermined conveyance device is outside the second region.

4. The press system according to claim 2 or 3, wherein
the first region and the second region are provided in association with the number of sizes of the dies that can be mounted on the front press device, and
the fourth region and the fifth region are provided in association with the number of sizes of the dies that can be mounted on the rear press device.

5. The press system according to claim 2, wherein
the press device has angle detection means configured to detect the angle of the crankshaft,
a signal corresponding to the angle of the crankshaft includes
an out-of-robot interference area signal corresponding to whether the angle detected by the angle detection means is outside a processing angle, which is an angle of the crankshaft from start to end of the processing by the press device, and
a bottom dead center signal corresponding to whether the angle detected by the angle detection means is at a bottom dead center,
the conveyance device has a hand for gripping the workpiece, and
a signal corresponding to the state of conveyance of the workpiece includes
an out-of-first region signal corresponding to whether the conveyance device is outside the first region,
an out-of-second region signal corresponding to whether the conveyance device is outside the second region,
an out-of-third region signal corresponding to whether the conveyance device is outside the third region,
an out-of-fourth region signal corresponding to whether the conveyance device is outside the fourth region,
an out-of-fifth region signal corresponding to whether the conveyance device is outside the fifth region,
an out-of-sixth region signal corresponding to whether the conveyance device is outside the sixth region,
a suction signal corresponding to whether the hand has gripped the workpiece, and
an in-conveyance signal corresponding to whether the hand is conveying the workpiece.

6. The press system according to claim 5, wherein a first condition is set to the first region, a second condition is set to the second region, a third condition is set to the third region, a fourth condition is set to the fourth region, a fifth condition is set to the fifth region, and a sixth condition is set to the sixth region,
the first condition being set to the first region and specifying that the front conveyance device is determined to be outside the sixth region based on the out-of-sixth region signal, the workpiece is determined to be in the front press device based on the suction signal, and the predetermined conveyance device is determined not to be in a process of being conveying based on the in-conveyance signal,
the second condition being set to the second region and specifying that the front conveyance device is determined to be outside the sixth region based on the out-of-sixth region signal, the front press device is determined to be outside the processing angle based on the out-of-robot interference area signal, a processed workpiece is determined to be inside the front press device based on the bottom dead center signal, and the predetermined conveyance device is determined not to be in the process of being conveying based on the in-conveyance signal,
the third condition being set to the third region and specifying that the front conveyance device is determined to be outside the sixth region based on the out-of-sixth region signal,
the fourth condition being set to the fourth region and specifying that the rear conveyance device is determined to be outside the third region based on the out-of-third region signal, no workpiece is determined to be in the rear press device based on the suction signal, and the predetermined conveyance device is determined not to be gripping the workpiece based on the suction signal,
the fifth condition being set to the fifth region and specifying that the rear conveyance device is determined to be outside the third region based on the out-of-third region signal, the rear press device is determined to be outside the processing angle based on the out-of-robot interference area signal, no workpiece is determined to be inside the rear press device based on the suction signal, and the predetermined conveyance device is determined not to be gripping the workpiece based on the suction signal,
the sixth condition being set to the sixth region and specifying that the rear conveyance device is determined to be outside the third region based on the out-of-third region signal.

7. The press system according to claim 6, wherein the entry permission signal includes a first entry permission signal, a second entry permission signal, a third entry permission signal, a fourth entry permission signal, a fifth entry permission signal, and a sixth entry permission signal, and
the control means
permits the predetermined conveyance device to enter an N-th region by the first entry permission signal when the first condition is met,
permits the predetermined conveyance device to enter the N-th region by the second entry permission signal when the second condition is met,
permits the predetermined conveyance device to enter the N-th region by the third entry permission signal when the third condition is met,
permits the predetermined conveyance device to enter the N-th region by the fourth entry permission signal when the fourth condition is met,
permits the predetermined conveyance device to enter the N-th region by the fifth entry permission signal when the fifth condition is met, and
permits the predetermined conveyance device to enter the N-th region by the sixth entry permission signal when the sixth condition is met.

8. The press system according to claim 1, wherein the control means is provided independently of the press device and the conveyance device.

9. A control method of a press system including:
a press device including a crankshaft and a slide configured to move up and down according to rotation of the crankshaft, the press device being configured to process a workpiece with dies mounted on the slide; a conveyance device configured to perform loading of the workpiece into the press device or unloading of the workpiece from the press device, and convey the workpiece; and control means configured to control the press device and the conveyance device,
the press system further including:
a predetermined conveyance device; a front press device disposed on an upstream side in a conveyance direction of the workpiece with respect to the predetermined conveyance device; a rear press device disposed on a downstream side in the conveyance direction with respect to the predetermined conveyance device; a front conveyance device disposed on the upstream side in the conveyance direction with respect to the predetermined conveyance device; a rear conveyance device disposed on the downstream side in the conveyance direction with respect to the predetermined conveyance device; and a storage unit configured to store information on multiple regions set to avoid interference between the predetermined conveyance device and the front press device, interference between the predetermined conveyance device and the rear press device, interference between the predetermined conveyance device and the front conveyance device, and interference between the predetermined conveyance device and the rear conveyance device,
the control method comprising:
sending, by each of the front press device and the rear press device, a signal corresponding to an angle of the crankshaft to the control means;
sending, by each of the predetermined conveyance device, the front conveyance device, and the rear conveyance device, a signal corresponding to a state of conveyance of the workpiece to the control means;
determining, by the control means, whether to permit entry to each of the multiple regions for each of the multiple regions based on signals corresponding to the angle of the crankshaft sent from the front press device and the rear press device, as well as signals corresponding to the state of conveyance of the workpiece sent from the predetermined conveyance device, the front conveyance device, and the rear conveyance device, and sending, by the control means, an entry permission signal for each of the multiple regions to the predetermined conveyance device based on determined results; and
performing, by the predetermined conveyance device, the loading or the unloading based on the entry permission signal.

10. The press system according to claim 3, wherein
the first region and the second region are provided in association with the number of sizes of the dies that can be mounted on the front press device, and
the fourth region and the fifth region are provided in association with the number of sizes of the dies that can be mounted on the rear press device.

11. The press system according to claim 2, wherein the control means is provided independently of the press device and the conveyance device.

12. The press system according to claim 3, wherein the control means is provided independently of the press device and the conveyance device.

13. The press system according to claim 5, wherein the control means is provided independently of the press device and the conveyance device.

14. The press system according to claim 6, wherein the control means is provided independently of the press device and the conveyance device.

15. The press system according to claim 7, wherein the control means is provided independently of the press device and the conveyance device.
